(19) United States
(12) Patent Application Publication
(10) Pub. No.: US 2016/0239286 A1
(43) Pub. Date: Aug. 18, 2016

(54) INFORMATION PROCESSING APPARATUS AND INSTALLATION METHOD

(71) Applicant: Hiroyuki Tanaka, Fukuoka (JP)

(72) Inventor: Hiroyuki Tanaka, Fukuoka (JP)

(73) Assignee: RICOH COMPANY, LTD., Tokyo (JP)

(21) Appl. No.: 15/001,560

(22) Filed: Jan. 20, 2016

(30) Foreign Application Priority Data
Feb. 17, 2015 (JP) 2015-028866

(51) Int. Cl. G06F 9/445; H04L 29/08

(52) U.S. Cl. CPC G06F 8/61; H04L 67/1097

(57) ABSTRACT

An information processing apparatus is provided that includes a first acquisition unit configured to acquire a data size of a program to be installed; a second acquisition unit configured to acquire an available storage capacity of a storage medium corresponding to an install location of the program; a determination unit configured to determine whether the program can be installed in the storage medium by calculating a consumption amount of storage capacity of the storage medium for storing the data size acquired by the first acquisition unit based on a smallest consumption unit of storage capacity of the storage medium, and comparing the calculated consumption amount with the available storage capacity; and an execution unit configured to install the program in the storage medium if the determination unit determines that the program can be installed in the storage medium.

### BACKGROUND OF THE INVENTION

1. Field of the Invention

The present invention relates to an information processing apparatus and an installation method.

2. Description of the Related Art

In certain devices such as image forming apparatuses, an application other than those preinstalled therein can be installed in order to enhance device functions, for example.

However, resources such as the flash memory of these devices are limited, and as such, the number of applications that can be installed in these devices is limited.

For example, when installing an application in a device, the storage capacity required for installing the application may exceed the available storage capacity of an install location of the device. In such case, even when attempts are made to install the application, installation may not be possible.

Such a problem is encountered not only in devices such as image forming apparatuses but also general-purpose information processing apparatuses such as personal computers (PC) and the like.

### SUMMARY OF THE INVENTION

In view of such problems of the related art, one aspect of the present invention is directed to enabling determination of whether a program can be installed.

According to one embodiment of the present invention, an information processing apparatus is provided that includes a first acquisition unit configured to acquire a data size of a program to be installed; a second acquisition unit configured to acquire an available storage capacity of a storage medium corresponding to an install location of the program; a determination unit configured to determine whether the program can be installed in the storage medium by calculating a consumption amount of storage capacity of the storage medium for storing the data size acquired by the first acquisition unit based on a smallest consumption unit of storage capacity of the storage medium, and comparing the calculated consumption amount with the available storage capacity; and an execution unit configured to install the program in the storage medium if the determination unit determines that the program can be installed in the storage medium.

### BRIEF DESCRIPTION OF THE DRAWINGS

FIG. 1 is a block diagram illustrating an exemplary hardware configuration of an image forming apparatus according to a first embodiment of the present invention;

FIG. 2 is a block diagram illustrating an exemplary functional configuration of the image forming apparatus according to the first embodiment;

FIG. 3 is a sequence chart illustrating exemplary processing procedures implemented in a case where installation is successful according to the first embodiment;

FIG. 4 is a table illustrating an exemplary configuration of information indicating the cluster size of each storage medium;

FIG. 5 is a sequence chart illustrating exemplary processing procedures implemented in a case where installation is unsuccessful according to the first embodiment;

FIG. 6 is a block diagram illustrating an exemplary functional configuration of an image forming apparatus according to a second embodiment of the present invention;

FIG. 7 is a sequence chart illustrating exemplary processing procedures implemented in a case where installation is successful according to the second embodiment;

FIG. 8 is a table illustrating an exemplary configuration of installation setting information;

FIG. 9 is a diagram illustrating an exemplary install location query screen;

FIG. 10 is a diagram illustrating an exemplary error screen;

FIG. 11 is a diagram illustrating an exemplary installation cancellation screen; and

FIG. 12 is a sequence chart illustrating exemplary processing procedures implemented in a case where installation is unsuccessful according to the second embodiment.

### DESCRIPTION OF THE PREFERRED EMBODIMENTS

An aspect of the present invention is directed to enabling determination of whether a program can be installed.

In one exemplary technique, each application may be arranged to submit information indicating a storage capacity required for installing the application, and upon installing a given application in a device, a determination may be made as to whether the given application can be installed in the device based on the submitted information and the storage capacity of the device.

However, owing to differences in the memory specification (e.g., cluster size) of the install location in which an application is to be installed, the physical memory consumption may potentially exceed the required storage capacity indicated in the information submitted by the application. In such a case, even when it is determined that the application can be installed, when attempts are made to actually install the application, installation of the application may not be possible.

Note that the memory specification of a device may vary depending on the device type, the model, and specification changes that have been implemented, for example. Therefore, it is difficult for the developer of an application to predict the physical memory consumption resulting from installing the application.

Such problems may be encountered not only in devices such as image forming apparatuses but also general purpose information processing apparatuses such as PCs, for example.

In view of the above, there is a demand for a technique for improving accuracy in determining whether a program can be installed.

In the following, embodiments of the present invention are described with reference to the accompanying drawings.

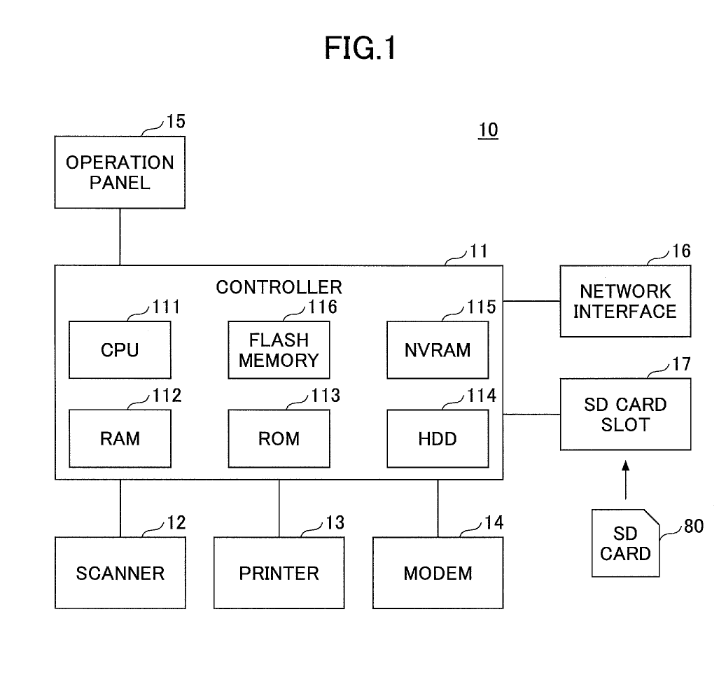

FIG. 1 is a block diagram illustrating an exemplary hardware configuration of an image forming apparatus 10 according to a first embodiment of the present invention. In FIG. 1, the image forming apparatus 10 includes a controller 11, a scanner 12, a printer 13, a modem 14, an operation panel 15, a network interface 16, and an SD card slot 17 as hardware elements.

The controller 11 includes a CPU (Central Processing Unit) 111, a RAM (Random Access Memory) 112, a ROM (Read-Only Memory) 113, a HDD (Hard Disk Drive) 114, a NVRAM (Non-Volatile RAM) 115, and a flash memory 116. The ROM 113 stores various programs and data to be used by the various programs, for example. The RAM 112 is used as a storage area for loading a program and as a working area for the loaded program. The CPU 111 executes the program loaded in the RAM 112 to implement various functions. The HDD 114 and the flash memory 116 store programs and various data to be used by the programs, for example. Note that a NAND (Not AND) type flash memory may be used as the flash memory 116, for example. The NVRAM 115 may store information such as the value of a counter that is updated in response to the execution of a job, for example.

The scanner 12 is hardware (image scanning unit) for scanning image data from a document. The printer 13 is hardware (print unit) for printing out print data on a print sheet. The modem 14 is hardware for establishing connection with a telephone line and is used to transmit/receive image data via facsimile communication. The operation panel 15 is hardware including an input unit such as a button for accepting a user input and a display unit such as liquid crystal display panel, for example. In some embodiments, the liquid crystal display panel may have a touch panel function. In such case, the liquid crystal display panel may also act as an input unit. The network interface 16 is hardware for establishing connection with a network such as a LAN (which may be wireless or wired). The SD card slot 17 is used to read a program stored in an SD card 80. Note that in some embodiments, some other type of recording medium such as a CD-ROM or a USB (Universal Serial Bus) may be used instead of the SD card 80. That is, the type of recording medium that may be used to implement the function of the SD card 80 in the image forming apparatus 10 is not particularly limited. In this case, the SD card slot 17 may be replaced by suitable hardware according to the type of recording medium used.

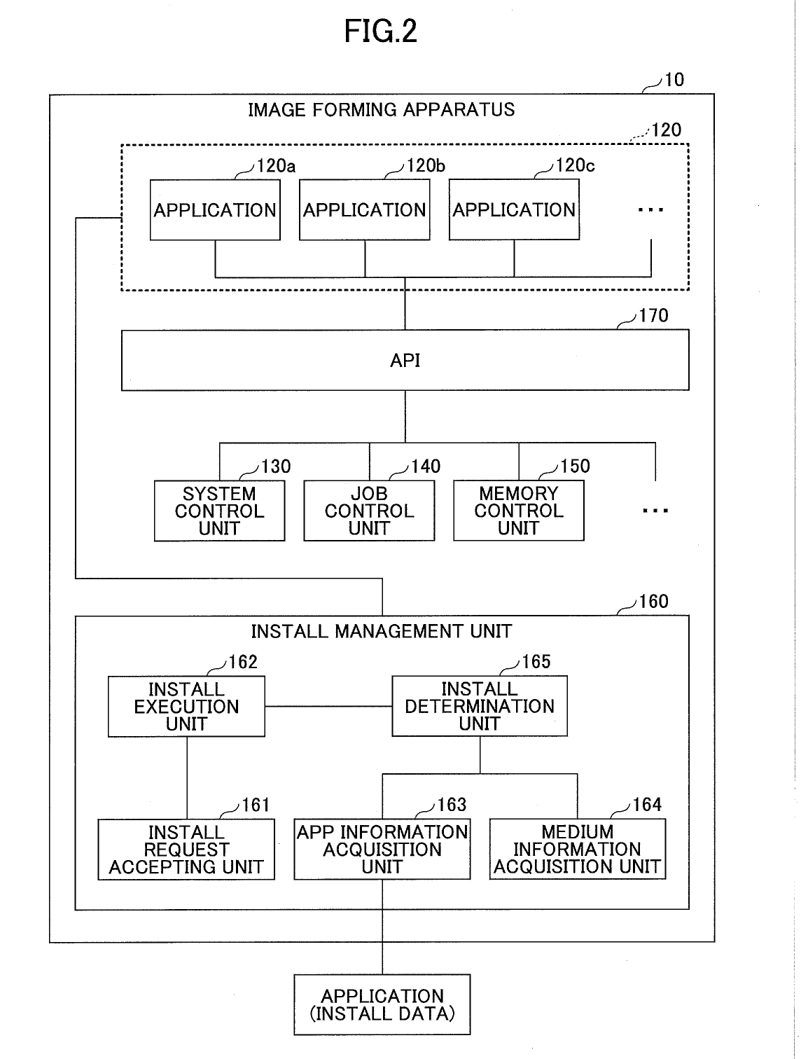

FIG. 2 is a block diagram illustrating an exemplary functional configuration of the image forming apparatus 10 according to the first embodiment. In FIG. 2, the image forming apparatus 10 includes at least one application 120 such as an application 120a, an application 120b, and an application 120c, a system control unit 130, a job control unit 140, a memory control unit 150, and an install management unit 160. These functional units may be implemented by the CPU 111 executing one or more relevant programs that are installed in the image forming apparatus 10, for example.

The application 120 is an application program for causing the image forming apparatus 10 to execute various processes for implementing a corresponding function of the application 120. For example, the application 120 may be configured to cause the image forming apparatus 10 to execute a process such as scanning, printing, copying, or facsimile transmission/reception.

The system control unit 130 performs overall operation control of the image forming apparatus 10. The job control unit 140 controls one or more jobs to be executed by the image forming apparatus 10. Examples of jobs that may be controlled by the job control unit 140 include a scan job, a print job, a copy job, a fax transmission job, a fax reception job, and the like. The memory control unit 150 controls utilization of the RAM 112 by software such as the application 120. Note that functions of the system control unit 130, the job control unit 140, and the memory control unit 150 may be used by the application 120 via an API (Application Program Interface) 170, for example.

The install management unit 160 controls an installation process for installing the application 120 in the image forming apparatus 10. In FIG. 2, the install management unit 160 includes an install request accepting unit 161, an install execution unit 162, an app information acquisition unit 163, a medium information acquisition unit 164, and an install determination unit 165.

The install request accepting unit 161 accepts an install request for installing the application 120 via the operation panel 15 or via a network, for example. The install execution unit 162 controls the installation process in accordance with the install request accepted by the install request accepting unit 161. Note that the application 120 to be installed and a storage medium to be used as the install location are designated in the install request. For example, the flash memory 116 or the HDD 114 may be designated as the install location of the application 120.

The app information acquisition unit 163 acquires the data size (e.g., file size) of each item of data (e.g., each file) included in a data group (e.g., file group) configuring the application 120 to be installed. Such information may be included in install data (e.g., install file) of the application 120 to be installed, for example. The medium information acquisition unit 164 acquires information on the remaining storage capacity (available storage capacity) of the storage medium corresponding to the install location for installing the application 120.

The install determination unit 165 determines whether the application 120 to be installed can be installed in the storage medium corresponding to the install location based on the data size acquired by the app information acquisition unit 163 and the available storage capacity acquired by the medium information acquisition unit 164. The install execution unit 162 executes an installation process for installing the application 120 if it is determined by the install determination unit 165 that installation of the program 120 is possible. The install execution unit 162 cancels the installation process if it is determined by the install determination unit 165 that installation of the program 120 is impossible.

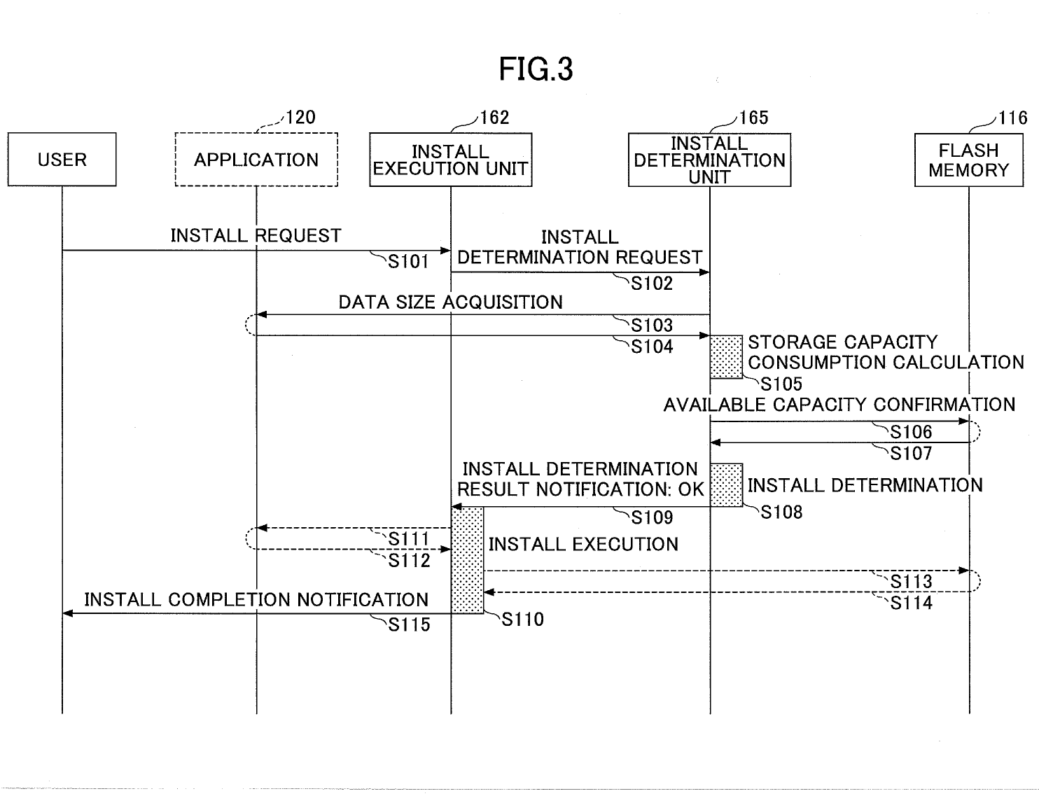

In the following, exemplary processing procedures implemented by the image forming apparatus 10 are described. FIG. 3 is a sequence chart illustrating exemplary processing procedures implemented in a case where installation is successful according to the first embodiment.

In step S101, the install execution unit 162 receives an install request for installing the application 120 via the install request accepting unit 161. Then, in step S102, the install execution unit 162 sends an install determination request to the install determination unit 165 specifying identification information of the application 120 to be installed (hereinafter referred to as “installing app information”) and identification information of the storage medium corresponding to the install location (hereinafter referred to as “install location information”) that are designated in the install request. The installing app information and the install location information may each indicate a file path name, for example. In the present example, it is assumed that the flash memory 116 has been designated as the storage medium corresponding to the install location.

Then, in steps S103 and S104, the install determination unit 165 acquires via the app information acquisition unit 163 the data size (e.g., actual file size) of data to be installed (data to be installed in the flash memory 116) that is included in the install data of the application 120 stored in a storage area (e.g., storage area of the SD card 80) that is specified by the installing app information.

Then, in step S105, the install determination unit 165 calculates the consumption amount (usage amount) of storage capacity of the flash memory 16 in the case where the data with the acquired data size is stored in the flash memory 116. Specifically, assuming C denotes the cluster size, R denotes the data size of the application 120 to be installed, and MR denotes the consumption amount of storage capacity of the flash memory 116 (storage capacity consumption), MR may be calculated based on formula (1) as indicated below.

MR=(INT(R/C)+1)×C (1)

In the above formula (1), INT(X) denotes the largest integer value that is less than or equal to X.

Note that the above formula (1) is a formula for converting a certain data size into a data size in cluster size units. That is, when storing data such as a file in a storage medium, the cluster size is the smallest unit of storage space (storage capacity) that is consumed (used) to store the data. In view of the above, formula (1) assumes that a multiple of the cluster size C that corresponds to the smallest value greater than or equal to the data size of the application 120 to be installed is the storage capacity consumption MR for installing the application 120 in the flash memory 116.

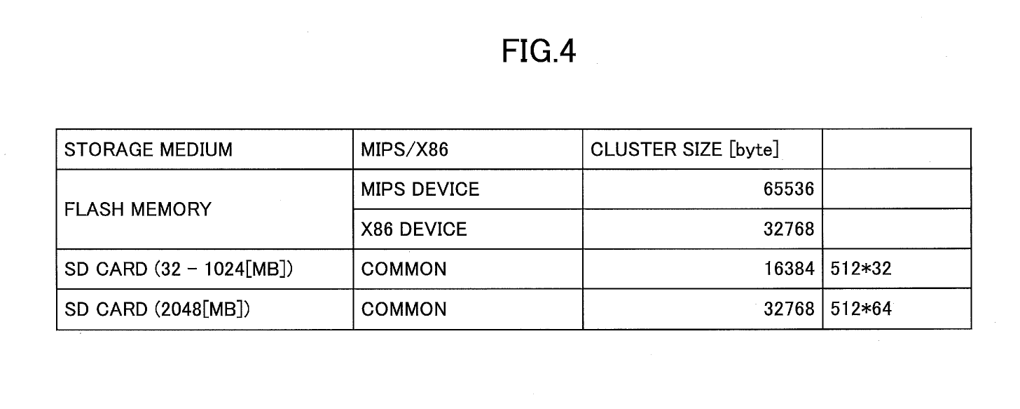

Note that the cluster size of the flash memory 116 may be obtained by making a query to the OS (Operating System) of the image forming apparatus 10, for example. Alternatively, information such as that illustrated in FIG. 4 may be stored in advance in the HDD 114, for example.

FIG. 4 illustrates an exemplary configuration of information indicating the cluster size of each storage medium. If information indicating the cluster size of each storage medium as illustrated in FIG. 4 is stored, the cluster size of the storage medium corresponding to the install location may be identified based on such information.

Then, in steps S106 and S107, the install determination unit 165 acquires the available storage capacity of the flash memory 116 corresponding to the install location via the medium information acquisition unit 164. Then, in step S108, the install determination unit 165 compares the storage capacity consumption MR calculated in step S105 with the available storage capacity of the flash memory 116, and determines whether the application 120 can be installed. For example, if the storage capacity consumption MR is less than or equal to the available storage capacity, it may be determined that installation is possible (OK). On the other hand, if the storage capacity consumption MR exceeds the available storage capacity, it may be determined that installation is impossible (N/A). Note that in some embodiments, in order to allow some leeway, a marginal amount a may be added to the storage capacity consumption MR and the value MR+a may be compared with the available storage capacity in the above determination process of step S108.

If it is determined that installation is possible (OK), in step S109, the install determination unit 165 notifies the install execution unit 162 of the determination result indicating that installation is possible. Then, in step S110, the install execution unit 162 receives the determination result and executes an installation process for installing the application 120. In the installation process, the install execution unit 162 acquires the install data of the application 120 from a storage area (e.g., storage area of the SD card 80) that is specified by the installing app information (steps S111 and S112). Then, the install execution unit 162 stores data included in the acquired install data in the flash memory 116 (steps S113 and S114). When the installation process is completed, in step S115, the install execution unit 162 executes a process for notifying the user of the completion of the installation process via the install request accepting unit 161. For example, in a case where the install request has been input via the operation panel 15, information indicating the completion of the installation process may be displayed at the operation panel 15. In a case where the install request has been input via a terminal (e.g., PC) connected to the image forming apparatus 10 via a network, information indicating the completion of the installation process may be transmitted to the terminal.

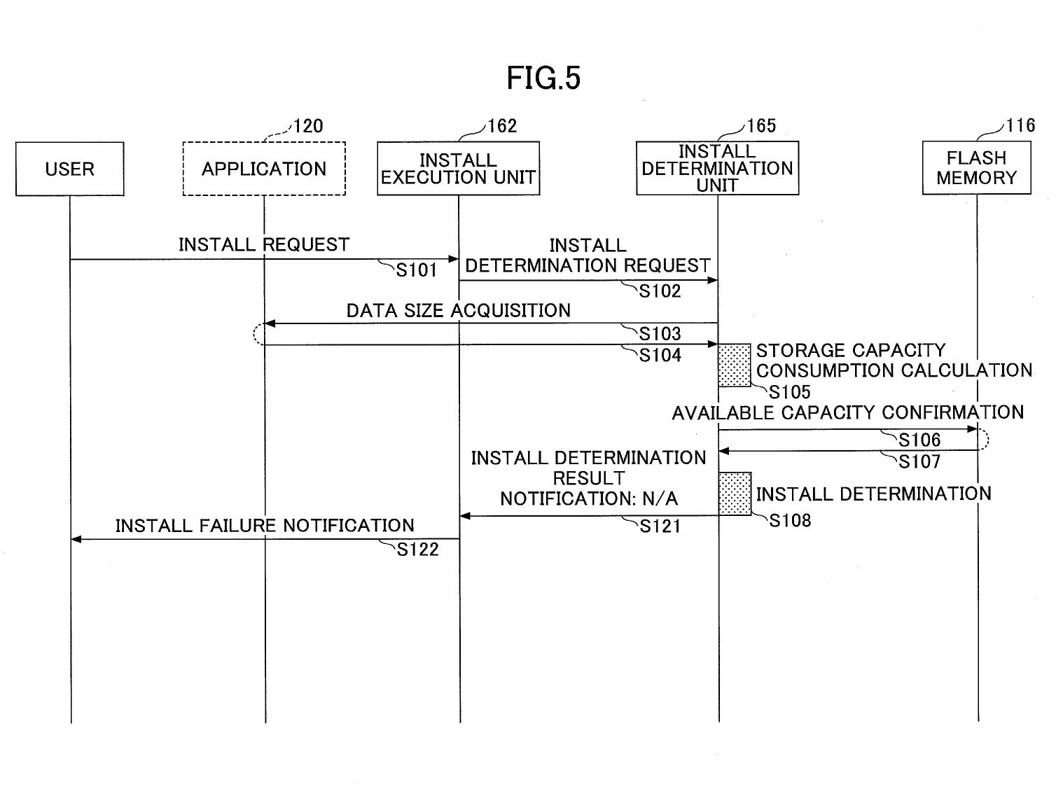

In the following, processing procedures implemented in a case where installation is unsuccessful are described. FIG. 5 is a sequence chart illustrating exemplary processing procedures implemented in the case where installation is unsuccessful according to the first embodiment. Note that in FIG. 5, process steps that are substantially identical to those illustrated in FIG. 3 are given the same reference numerals, and descriptions thereof may be omitted.

In the example of FIG. 5, in step S108, the install determination unit 165 determines that the storage capacity consumption MR or MR+a exceeds the available storage capacity of the flash memory 116. Accordingly, in step S121, the install determination unit 165 notifies the install execution unit 162 of the determination result indicating that installation is impossible (N/A). In response to the determination result, in step S122, the install execution unit 162 cancels the installation process and executes a process for notifying the user of the failure of the installation process. Note that the method used to notify the user of the installation failure may be substantially similar to the method used to notify the user of the completion of the installation process, for example.

As described above, according to the first embodiment, the data size (file size) of the application 120 to be installed is evaluated based on the cluster size, which is the smallest unit of storage capacity that is physically consumed. The evaluation result is then compared with the available storage capacity of the storage medium corresponding to the install location, and a determination is made as to whether installation of the application 120 is possible. In this way, whether installation is possible may be determined based on the amount of storage capacity that is actually consumed upon installing the application 120 in the storage medium corresponding to the install location. As a result, accuracy may be improved in determining whether the application 120 can be installed.

In the following, a second embodiment of the present invention is described. Note that the descriptions below mainly relate to features of the second embodiment that differ from those of the first embodiment. Accordingly, it may be assumed that features of the second embodiment that are not specifically mentioned below may be substantially identical to those of the first embodiment.

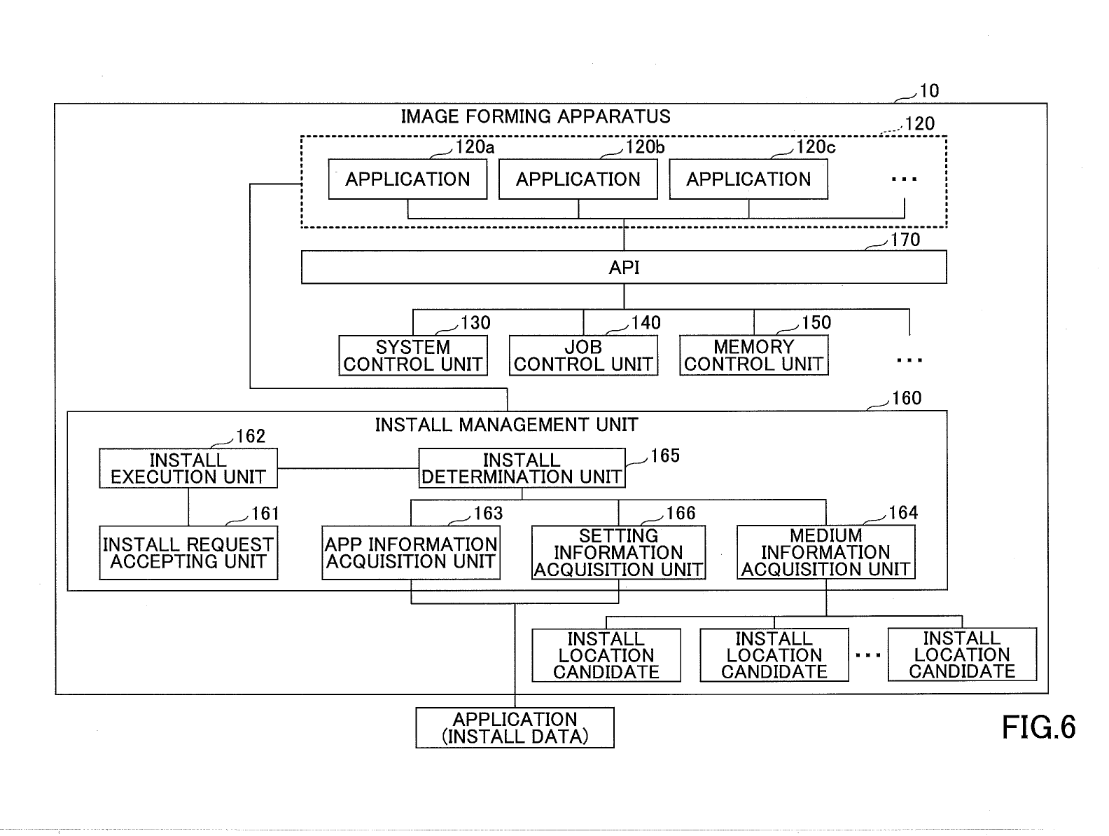

FIG. 6 is a block diagram illustrating an exemplary functional configuration of the image forming apparatus 10 according to the second embodiment. Note that elements illustrated in FIG. 6 that are substantially identical to those illustrated in FIG. 2 are given the same reference numerals and descriptions thereof are omitted.

In FIG. 6, a plurality of types of storage media (e.g., the flash memory 116, the HDD 114, and the SD card 80) are illustrated as install location candidates. That is, the medium information acquisition unit 164 is capable of acquiring the available storage capacity of a plurality of storage media corresponding to install location candidates.

In FIG. 6, the image forming apparatus 10 further includes a setting information acquisition unit 166. The setting information acquisition unit 166 acquires setting information for determining the storage medium to be used as the install location (hereinafter referred to as “install setting information”) that is included in the install data of the application 120.

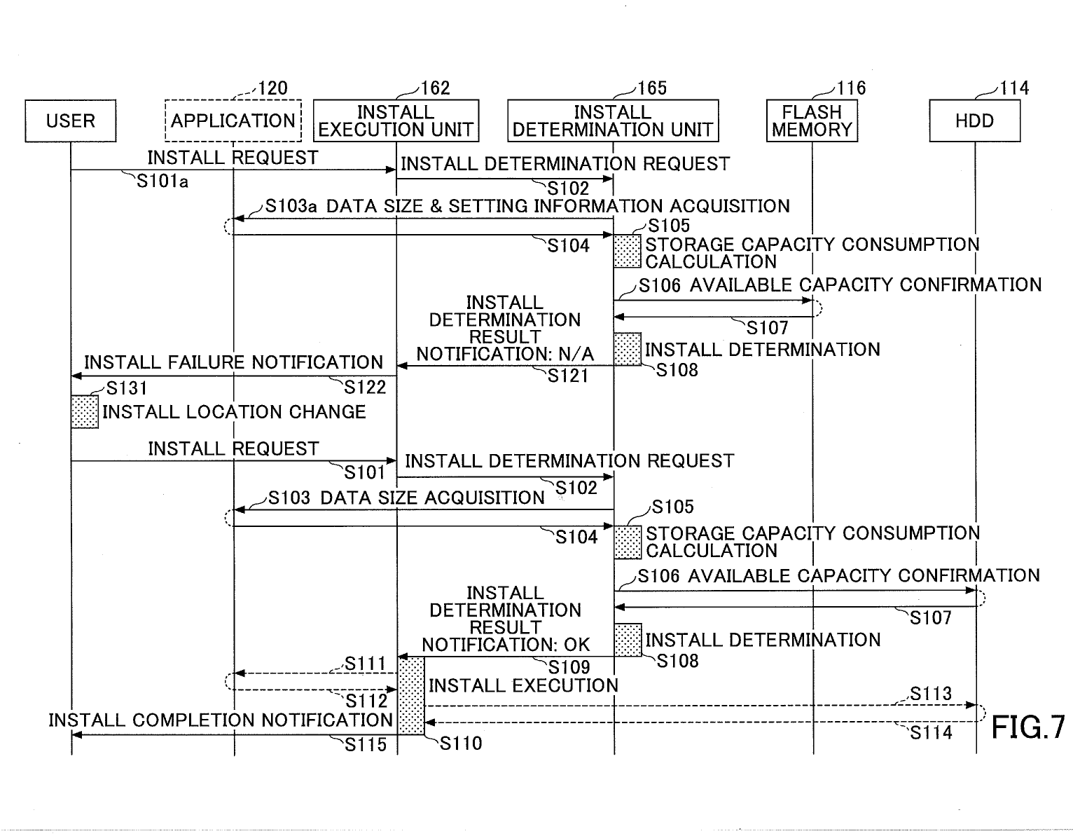

FIG. 7 is a sequence chart illustrating exemplary processing procedures implemented in a case where installation is successful according to the second embodiment. Note that process steps illustrated in FIG. 7 that are identical or correspond to the process steps illustrated in FIG. 3 and/or FIG. 5 are given the same reference numerals and descriptions thereof are omitted.

In step S101a of FIG. 7, the storage medium to be used as the install location is not designated in the install request. That is, according to the second embodiment, the storage medium to be used as the install location is determined based on the install setting information.

In step S103a, the install determination unit 165 acquires the install setting information in addition to the data size of the data to be installed from the install data of the application 120. The install setting information is acquired via the setting information acquisition unit 166.

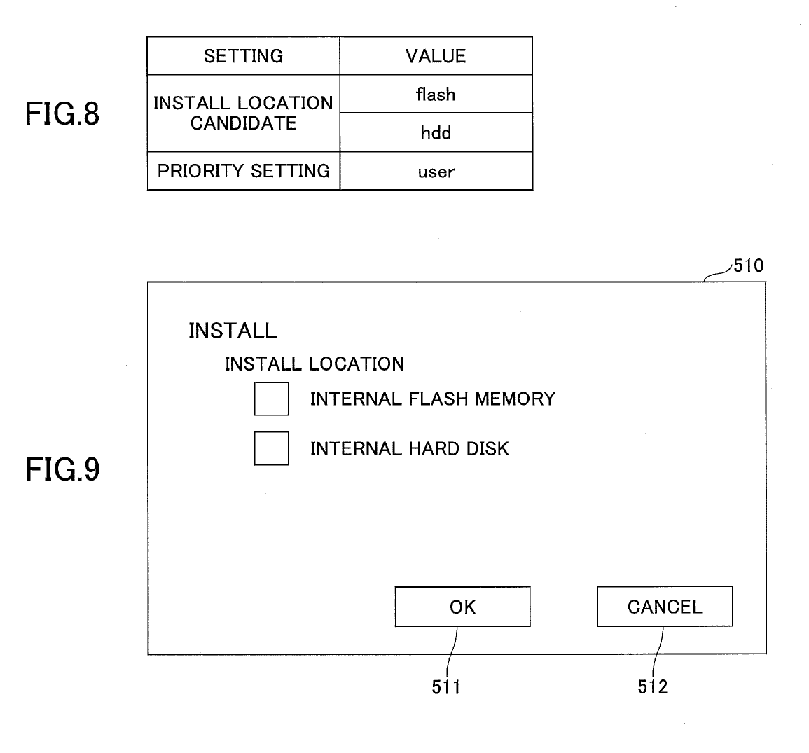

FIG. 8 is a table illustrating an exemplary configuration of the install setting information. As illustrated in FIG. 8, the install setting information may include “install location candidate” and “priority setting” as setting items and corresponding values thereof.

The “install location candidate” is setting information indicating a storage medium corresponding to an install location candidate for installing the application 120. Note that one or more values may be set up for the install location candidate. Examples of values that may be set up for the install location candidate include “system”, “flash”, “hdd”, and “sdcard”. The value “system” indicates that the install location is to be determined according to the setting of the image forming apparatus 10 in which the application 120 is to be installed. In other words, the value “system” is a valid value if the storage medium to be used as the install location of the application 120 is set up in the image forming apparatus 10. The value “flash” represents the flash memory 116. The value “hdd” represents the HDD 114. The value “sdcard” represents the SD card 80. Note that in a case where the image forming apparatus 10 includes a plurality of SD card slots 17, for example, values such as “sdcard1”, “sdcard2”, and “sdcard3” may be set up in order to distinguish each SD card 80 of each SD card slot 17.

In FIG. 8, “flash” and “hdd” are set up as values for the “install location candidate”. Thus, in this example, the flash memory 116 and the HDD 114 correspond to install location candidates for installing the application 120.

“Priority setting” is setting information indicating a method for determining a priority order among the install location candidates. Examples of values that may be set up for the “priority setting” include “system”, “application”, and “user”. The value “system” indicates that the priority order is to be determined based on a priority order set up in the image forming apparatus 10 in which the application 120 is to be installed. The value “application” indicates that the priority order is to be determined based on a setting in the application 120 to be installed. Note that the setting in the application 120 to be installed refers to the order in which the values of the install location candidates are listed in the install setting information of the application 120. For example, in FIG. 8, the values of the install location candidates are listed in the following order: “flash”, “hdd”. Therefore, the priority order of the install location candidates follows this order (i.e., “flash” is given priority over “hdd”). The value “user” indicates that install operations are to be performed according to a setting by the user.

In FIG. 8, “user” is set up as the value of the priority setting. Thus, in this example, the user determines the priority order of the install location candidates.

When “user” is set up as the value of the priority setting in the install setting information, the install determination unit 165 requests the install execution unit 162 to make an install location query before executing step S105. That is, the install determination unit 165 makes a query to the user via the install execution unit 162 about the storage medium to be used as the install location. For example, the query to the user may be implemented by an install location query screen 510 as illustrated in FIG. 9.

FIG. 9 illustrates an example of the install location query screen 510. In FIG. 9, the install location query screen 510 includes a check button for each install location candidate, an OK button 511, and a cancel button 512. Note that in the case where the install request is input via the operation panel 15, the install location query screen 510 may be displayed at the operation panel 15. In the case where the install request is input via a terminal that is connected to the image forming apparatus 10 via a network, the install location query screen 510 may be displayed at the terminal.

For example, in a case where the check box corresponding to the flash memory 116 (“INTERNAL FLASH MEMORY”) is selected, and the OK button 511 is pressed in the install location query screen 510, the flash memory 116 is set up as the install location, and the processes of steps S105 to S108 are executed. That is, in this case, in step S105, the cluster size of the flash memory 116 is assigned to the cluster size C of the above formula (1), and the storage capacity consumption MR is calculated. Note that in the case where the value of the priority setting of the install setting information is set to “system” or “application”, the install determination unit 165 automatically selects the storage medium to be used as the install location according to the setting in the image forming apparatus 10 or the application 120 without displaying the install location query screen 510 and executes the processes of steps S105 to S108 thereafter.

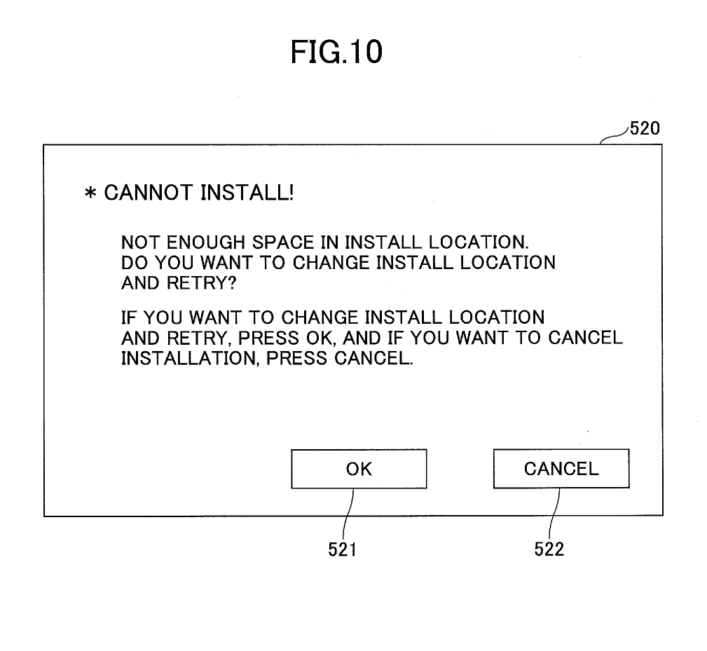

In the following, an exemplary case where it is determined in step S108 that the storage capacity consumption MR or MR+a exceeds the available storage capacity of the flash memory 116 is described. In this case, the processes of steps S121 and S122 as illustrated in FIG. 5 are performed after step S108. Note, however, that in the present embodiment, in step S122, an error screen 520 as illustrated in FIG. 10 may be displayed.

FIG. 10 illustrates an example of the error screen 520. In FIG. 10, the error screen 520 includes a message indicating that the available storage capacity of the install location is not enough. When the user presses an OK button 521 in order to change the install location and retry the installation process, the install determination unit 165 displays the install location query screen 510 of FIG. 9 once again.

When the install location query screen 510 is displayed once again, for example, the check button corresponding to the HDD 114 (“INTERNAL HARD DISK”) may be selected and the OK button 511 may be pressed. In response, the processes of step S101 and subsequent steps may be re-executed. Note that upon re-executing the process of step S105 in the present example, the cluster size of the HDD 114 is assigned to the cluster size C of the above formula (1) in calculating the storage capacity consumption MR. Also, upon re-executing the process of step S108, if it is determined that installation of the program 120 is possible, the processes of steps S109 to S115 as illustrated in FIG. 3 may be executed. In this case, the application 120 to be installed may be installed in the HDD 114.

Note that in a case where the value of the priority setting of the install setting information is set to “system” or “application”, the processes of steps S121 and S122 are not executed. In this case, the install determination unit 165 automatically selects the install location candidate that is next in line according to the pre-designated priority setting and executes the processes of step S105 and subsequent steps with respect to the selected install location candidate.

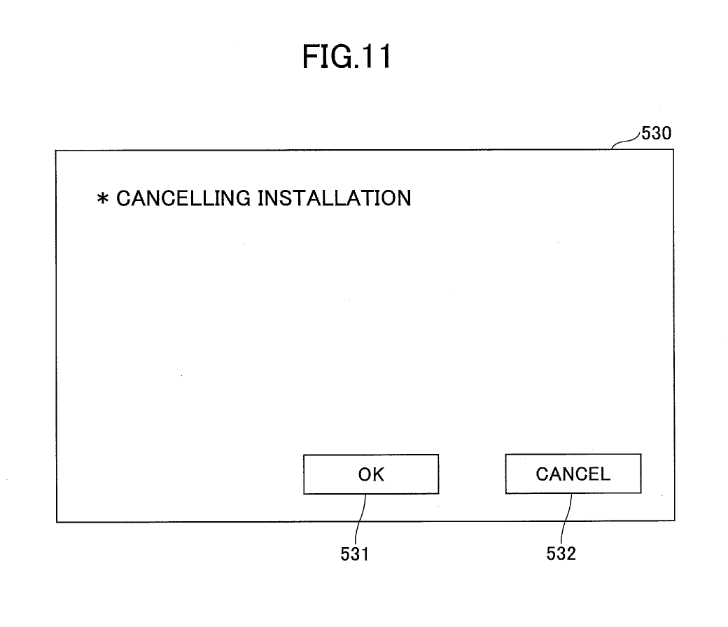

Note that in a case where the cancel button 512 is pressed while the install location query screen 510 is displayed, or in a case where the cancel button 522 is pressed while the the error screen 520 is displayed, the install determination unit 165 may display an install cancellation screen 530 as illustrated in FIG. 11, for example.

FIG. 11 illustrates an example of the install cancellation screen 530. As illustrated in FIG. 11, the install cancellation screen 530 includes a message indicating that the installation process will be cancelled. When an OK button 531 is pressed by the user, the installation process may be cancelled. When a cancel button 532 is pressed by the user, the install location query screen 510 may be displayed once again.

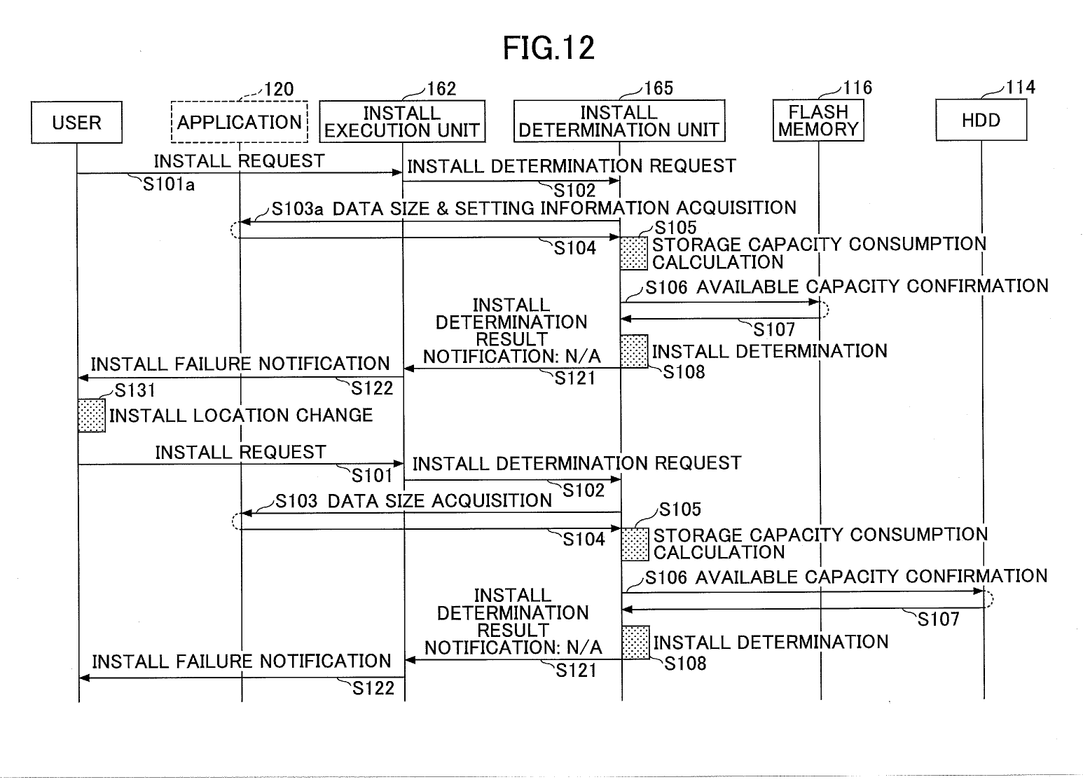

In the following, processing procedures implemented in a case where installation is unsuccessful according to the present embodiment are described. FIG. 12 is a sequence chart illustrating exemplary processing procedures implemented in the case where installation is unsuccessful according to the second embodiment. Note that process steps illustrated in FIG. 12 that may be substantially identical to those illustrated in FIG. 7 are given the same reference numerals and descriptions thereof are omitted.

FIG. 12 illustrates an exemplary case where it is determined in step S108 that installation of the program 120 is impossible (N/A) even when the install location is changed and the installation process is retried. That is, it is determined that even the HDD 114 does not have enough storage space (storage capacity) to install the application 120. Accordingly, in the present example, after the determination process of step S108 is executed for the second time, the processes of steps S121 and S122 are executed.

Note that in the examples described above, the determination of whether the application 120 can be installed in the plurality of install location candidates is performed with respect to one install location candidate at a time in the designated priority order set up with respect to the application 120 in the install setting information, and the application 120 is installed in the storage medium corresponding to the first install location candidate that has been determined to be capable of storing the application 120. However, in some embodiments, the determination of whether installation is possible may be performed with respect to all of the install location candidates, and the application 120 may be installed in the storage medium corresponding to the install location candidate that is ranked first in priority order among the install location candidates that have been determined to be capable of storing the application 120, for example. That is, the detailed procedures for determining the install location from among the plurality of install location candidates is not particularly limited and may be suitably changed as long as the same determination result can ultimately be obtained.

As described above, according to the second embodiment, a plurality of storage media may be provided as install location candidates. Therefore, even if a first storage medium corresponding to an install location candidate ranked first in priority order does not have enough storage space (storage capacity), if a second storage medium corresponding to an install location candidate ranked second in the priority order has enough storage space, an application may be successfully installed in the second storage medium, for example. In this way, the success rate of the installation process for installing the application 120 may be increased.

Note that the embodiments described above are not limited to being implemented by the image forming apparatus 10 but may be applied to other devices and information processing apparatuses that are capable of installing a program. For example, embodiments of the present invention may be applied to a PC (Personal Computer), a smart phone, a tablet computer, a projector, a video conference system, a digital camera, an electronic blackboard, and the like. Also, the above-described embodiments may be used in the installation of a program other than an application program, for example.

Note that the image forming apparatus 10 of the above-described embodiments is an example of an information processing apparatus according to the present invention. The app information acquisition unit 163 is an example of a first acquisition unit. The medium information acquisition unit 164 is an example of a second acquisition unit. The install determination unit 165 is an example of a determination unit. The install execution unit 162 is an example of an execution unit.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any non-transitory storage medium for storing processor readable code such as a floppy disk, a hard disk, a CD ROM, a magnetic tape device or a solid state memory device. The non-transitory storage medium can comprise any computer-readable medium except for a transitory, propagating signal.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

Although the present invention has been described above with reference to certain illustrative embodiments, the present invention is not limited to these embodiments, and numerous variations and modifications may be made without departing from the scope of the present invention. The present application is based on and claims the benefit of priority of Japanese Patent Application No. 2015-028866 filed on Feb. 17, 2015, the entire contents of which are hereby incorporated by reference.

What is claimed is:

1. An information processing apparatus comprising:
a first acquisition unit configured to acquire a data size of a program to be installed;
a second acquisition unit configured to acquire an available storage capacity of a storage medium corresponding to an install location of the program;
a determination unit configured to determine whether the program can be installed in the storage medium by calculating a consumption amount of storage capacity of the storage medium for storing the data size acquired by the first acquisition unit based on a smallest consumption unit of storage capacity of the storage medium, and comparing the calculated consumption amount with the available storage capacity; and
an execution unit configured to install the program in the storage medium if the determination unit determines that the program can be installed in the storage medium.

2. The information processing apparatus as claimed in claim 1, wherein
the determination unit calculates a smallest value that is greater than or equal to the data size acquired by the first acquisition unit and is a multiple of the smallest consumption unit.

3. The information processing apparatus as claimed in claim 1, wherein
the second acquisition unit acquires the available storage capacity of a plurality of storage media;
the determination unit determines whether the program can be installed in a specific storage medium of the plurality of storage media by calculating the consumption amount of storage capacity of the specific storage medium for storing the data size acquired by the first acquisition unit based on the smallest consumption unit of storage capacity of the specific storage medium, and comparing the calculated consumption amount for the specific storage medium with the available storage capacity of the specific storage medium; and
the execution unit installs the program in the specific storage medium of the plurality of storage media that has been determined by the determination unit to be capable of storing the program.

4. The information processing apparatus as claimed in claim 3, wherein
the determination unit determines whether the plurality of storage media are capable of storing the program in a designated order set up with respect to the program; and
the execution unit installs the program in a first storage medium that is first among the plurality of storage media to be determined by the determination unit to be capable of storing the program.

5. The information processing apparatus as claimed in claim 3, wherein
the determination unit makes an install location query to a user about the specific storage medium among the plurality of storage media that is to be used as the install location until the determination unit determines that the specific storage medium among the plurality of storage media is capable of storing the program.

6. An installation method that is implemented by an information processing apparatus, the installation method comprising:
a first acquisition step of acquiring a data size of a program to be installed;
a second acquisition step of acquiring an available storage capacity of a storage medium corresponding to an install location of the program;
a determination step of determining whether the program can be installed in the storage medium by calculating a consumption amount of storage capacity of the storage medium for storing the data size acquired in the first acquisition step based on a smallest consumption unit of storage capacity of the storage medium, and comparing the calculated consumption amount with the available storage capacity; and
an execution step of installing the program in the storage medium if it is determined in the determination step that the program can be installed in the storage medium.

7. The installation method as claimed in claim 6, wherein
the determination step includes calculating a smallest value that is greater than or equal to the data size acquired in the first acquisition step and is a multiple of the smallest consumption unit.

8. The installation method as claimed in claim 6, wherein
the second acquisition step includes acquiring the available storage capacity of a plurality of storage media;
the determination step includes determining whether the program can be installed in a specific storage medium of the plurality of storage media by calculating the consumption amount of storage capacity of the specific storage medium for storing the data size acquired in the first acquisition step based on the smallest consumption unit of storage capacity of the specific storage medium, and comparing the calculated consumption amount for the specific storage medium with the available storage capacity of the specific storage medium; and
the execution step includes installing the program in the specific storage medium of the plurality of storage media that has been determined in the determination step to be capable of storing the program.

9. The installation method as claimed in claim 8, wherein
the determination step includes determining whether the plurality of storage media are capable of storing the program in a designated order set up with respect to the program; and
the execution step includes installing the program in a first storage medium that is first among the plurality of storage media to be determined in the determination step to be capable of storing the program.

10. The installation method as claimed in claim 8, wherein
the determination step includes making an install location query to a user about the specific storage medium among the plurality of storage media that is to be used as the install location until the specific storage medium among the plurality of storage media is determined to be capable of storing the program.

11. A computer program product comprising a non-transitory computer-readable medium having a computer program recorded thereon that is executable by a computer, the computer program when executed causing the computer to perform:
a first acquisition step of acquiring a data size of a program to be installed;
a second acquisition step of acquiring an available storage capacity of a storage medium corresponding to an install location of the program;
a determination step of determining whether the program can be installed in the storage medium by calculating a consumption amount of storage capacity of the storage medium for storing the data size acquired in the first acquisition step based on a smallest consumption unit of storage capacity of the storage medium, and comparing the calculated consumption amount with the available storage capacity; and
an execution step of installing the program in the storage medium if it is determined in the determination step that the program can be installed in the storage medium.

12. The computer program product as claimed in claim 11, wherein
the determination step includes calculating a smallest value that is greater than or equal to the data size acquired in the first acquisition step and is a multiple of the smallest consumption unit.

13. The computer program product as claimed in claim 11, wherein
the second acquisition step includes acquiring the available storage capacity of a plurality of storage media;
the determination step includes determining whether the program can be installed in a specific storage medium of the plurality of storage media by calculating the consumption amount of storage capacity of the specific storage medium for storing the data size acquired in the first acquisition step based on the smallest consumption unit of storage capacity of the specific storage medium, and comparing the calculated consumption amount for the specific storage medium with the available storage capacity of the specific storage medium; and
the execution step includes installing the program in the specific storage medium of the plurality of storage media that has been determined in the determination step to be capable of storing the program.

14. The computer program product as claimed in claim 13, wherein
the determination step includes determining whether the plurality of storage media are capable of storing the program in a designated order set up with respect to the program; and
the execution step includes installing the program in a first storage medium that is first among the plurality of storage media to be determined in the determination step to be capable of storing the program.

15. The computer program product as claimed in claim 13, wherein
the determination step includes making an install location query to a user about the specific storage medium among the plurality of storage media that is to be used as the install location until the specific storage medium among the plurality of storage media is determined to be capable of storing the program.
